(19) United States
(12) Patent Application Publication
(10) Pub. No.: US 2003/0001079 A1
(43) Pub. Date: Jan. 2, 2003

(54) Current mode pixel amplifier

(76) Inventor: Christian Boemler, Cortland, NY (US)

Correspondence Address: Bernhard P. Molldrem, Jr., 2nd Floor, Monroe Building, 333 East Onondaga Steet, Syracuse, NY, 13202, US

(21) Appl. No.: 10/114,731

(22) Filed: Apr. 2, 2002

Related U.S. Application Data
(60) Provisional application No. 60/280,151, filed on Apr. 2, 2001.

(51) Int. Cl. H01L 27/00

(52) U.S. Cl. 250/208.1

(57) ABSTRACT

In a current mode pixel readout structure, a pixel diode is kept at a constant voltage and the current charges an integrator to minimize dark current, minimize pixel to pixel variations, eliminate KTC noise, and to minimize the signal noise bandwidth.

### BACKGROUND OF THE INVENTION

This invention concerns solid state imagers, and in particular is directed to an improved pixel amplifier arrangement for obtaining high uniformity and improved image quality and reliability. Solid state image sensors are used in a wide variety of applications, and there has been much interest in pursuing low-cost, high-reliability image sensors. CMOS technology is well suited for imagers that are intended for portable applications, because of their need for a only a single power supply voltage, their ruggedness, and their inherent low power consumption. There has been great interest in achieving extremely high resolution also, which requires increased pixel density. As imagers are designed with more and more pixels, then the need for multiplexing the pixel output voltages become more and more difficult. Typically, these have to be multiplexed off-chip.

An active column sensor (ACS) architecture has recently been developed, as disclosed in Pace et al. U.S. Pat. No. 6,084,229, and which permits a CMOS image sensor to be constructed as a single-chip video camera with a performance equal to or better than that which may be achieved by CCD or CID imagers. However, it has been difficult to achieve high uniformity from pixel to pixel in these imagers, and they have exhibited some problems, such as fixed pattern noise, or FPN. The above-mentioned patent addresses one means for improving the CMOS image sensor and combating FPN. However, some problems also arise because of the way that the video pixel levels are integrated on the pixel area and then read out.

As will be seen, with a current mode pixel readout arrangement, offsets in the amplifier elements are minimized, and this eliminates a lot of the variation from pixel to pixel. Also, the quality of the signal is kept high despite problems that might otherwise arise from signal routing paths.

CMOS imagers are gaining widespread use because of their low cost and high level of integration in many applications. More specifically, imagers that are fabricated on standard or nearly standard CMOS can utilize and merge-in other existing circuits designed for CMOS. Unfortunately, CMOS imagers still have a few drawbacks, such as lower sensitivity and higher levels of dark current.

Sensitivity is an important issue for imagers, and is often defined as the ability of a pixel system or structure to convert photons into useable levels of signal at the output of the imaging device. The number photons sufficient to produce a signal equal to the noise level is considered the minimum useable light level at which a given imager can be used, and is referred as Noise Equivalent Product (NEP). CMOS imagers are considered to have a low sensitivity because of the necessary electronics needed per pixel, which blocks light from being collected and the existing noise floor. If a pixel structure in a CMOS imager is able to reduce the noise floor by lowering the noise sources like kTC (thermal noise), minimizing the bandwidth and lowering dark current, then sensitivity can be improved. As a result, the pixel structure needs a way to reduce the noise.

Dark current is the result of unwanted signal being collected inside of the photodiode structure that defines the collection area of the pixel structure and has two major sources, namely, processing variables and pixel biasing. The “dark current” is charge or error signal level that is able to leak across the photodiode junction. Processing is totally foundry dependant and is outside the ability of the circuit designer to control. Foundries now publish the dark current levels as a figure of merit. As an attempt to reduce the leakage of charge or dark current, designers of imagers and pixel structures reduce the potential applied across the reverse-biased photodiode junction to the minimum allowable possible for a given application. If the bias is kept at a minimum across the diode junction, the total dynamic range of the diode will be small. Typically a pixel works by resetting the pixel diode to a higher voltage and lettting the lightdependent leakage current discharge the effective diode capacitor during exposure. Thereafter the pixel voltage drop is sampled and that voltage drop is a function of the light hitting the pixel site and the capacitance on that pixel. The greater the reverse potential (Voltage) the greater the signal swing can be across the diode; but, at the expense of higher dark current.

Another problem is uniformity from pixel to pixel, which generates what is known as Fixed Pattern Noise (FPN). The pixel capacity of the pixel diode can vary a great deal from pixel to pixel as well as the sensitivity is inversely proportional to the pixel capacity. With many types of image sensors—especially color linear—the pixels have to be routed from the pixel site to the pixel amplifier in metal layers. Any differences in routing length will give rise to a different capacity and hence sensitivity.

Another problem is that the dark current is reverse voltage dependent and the voltage drop from this element will be a non-linear addition to the drop originating from the incoming light. Dark current can be kept to a minimum if the pixel is kept at a constant, low voltage.

### OBJECTS AND SUMMARY OF THE INVENTION

It is an object to maximize the sensitity of a solid-state imager, and at the same time to control the effects of dark current, noise, and other factors that reduce sensitivity.

It is a further object to produce an improved CMOS imager.

According to an aspect of the invention, a current mode pixel amplifier arrangement employs pixels that are each a photosensitive element that has one electrode connected to a common terminal and a signal electrode, with a load capacitance parallel to the photosensitive element. An amplifier has a first input connected to the signal electrode; a second input connected to a point of pixel bias; and an output. A feedback capacitor is connected between the first input of the amplifier and the amplifier output, with an integration switch situated between the feedback capacitor and the amplifier output. A bias means places a black level bias on the feedback capacitor, and a resetting means for resets the feedback capacitor.

### BRIEF DESCRIPTION OF DRAWINGS

FIG. 1 shows a typical prior-art linear photo-diode pixel

FIG. 2 illustrates a Current-Mode, constant photodiode feedback kTC-noise-free linear pixel amplifier, according to one embodiment of this invention.

### DESCRIPTION OF THE PREFERRED EMBODIMENT

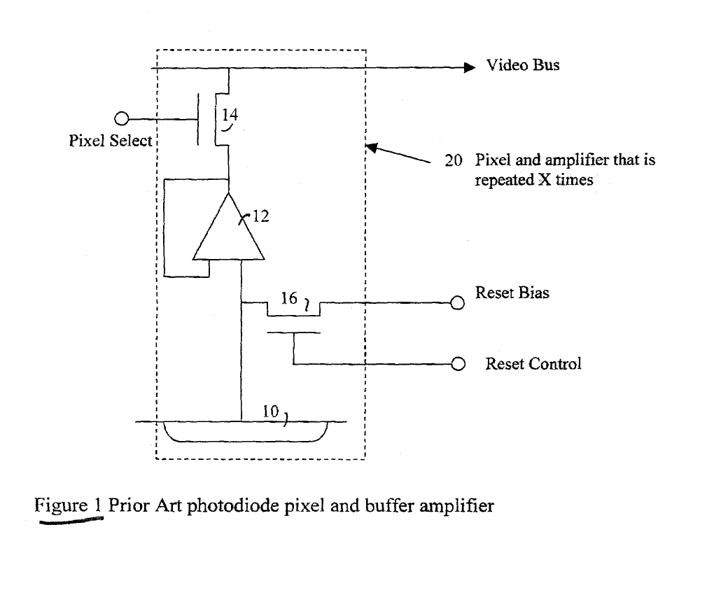

FIG. 1 is typical prior art linear array where only one of the pixel and amplifer combinations is shown 20. The array can be any desired number of pixel and amplifier units desired for the application. The pixel and amplifier units 20 are each comprised of the photodiode 10 that is reverse-biased through the Reset FET 16 and buffered by amplifier 12, and selected for reading by the Pixel Select FET 14 to the video bus. The operation of the pixel is as described previously, where the photodiode is reverse-biased and in this example, for a 5.0 Volt process, is biased at 4.2 Volts. 4.0 Volts is the resultant pixel value after accounting for the threshold drop of the Reset FET 16 which is a NFET and for level shift due to charge injection of turning “off” the NFET. The photon-generated charge decays the 4.0 Volt initial value towards zero. The point at which the pixel amplifier combination 20 is selected by the Pixel Select FET 14 is the resultant video value. The high bias of 4.0 Volts allows for high dark current. To eliminate kTC noise the video will have to be sampled just after Pixel Reset has occurred for proper Correlated Double Sampling (CDS). In order to do this in prior art a CDS circuit has to be added after the amplifer 12 at the expense of added transistors and has been implemented as described generally in U.S. Pat. No. 6,084,229. Also, the unity gain amplifier is has a very high bandwidth that is difficult to compensate, in modern sub-micron processes, to the low bandwidth needed to most applications.

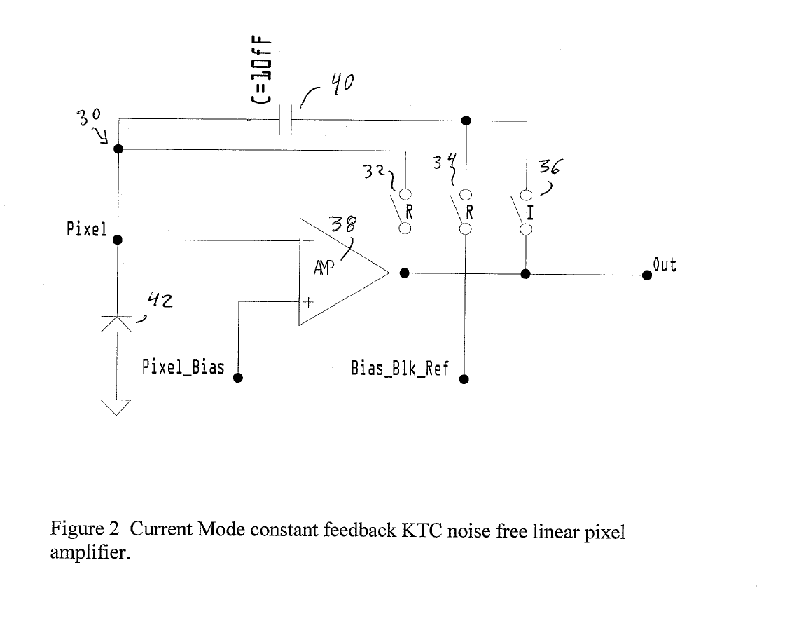

FIG. 2 shows pixel arrangement of the present invention, with a greatly improved circuit configuration that will eliminate kTC noise, minimize the reverse bias potential across the photo-diode, minimize the capacitance variation from pixel to pixel; while, maintaining a low bandwidth to match the application. The amplifier feedback-loop 30 keeps the pixel virtually at Pixel_Bias, which is the constant pixel operating voltage. The switches labeled 32, 43 and 36 are shown for simplicity and can be implemented simply as NFETs for this example. An actual implementation may have many variants such as transmission gate, compensated dummy FETs and other methods known by those skilled in the art. The N-FET's 32, 34 are activated during pixel reset (marked “R”) and the N-FET 36 is activated during integration (marked “I”). The amplifier 38 offset can be modeled as Negative input=Pixel_Bias+Offset, the left side of the feedback capacitor 40 will be reset to that voltage and the right side reset to Bias_Blk_Ref (a black reference voltage). The “offset” is due to the fact that all operational amplifiers have a built in offset, and any precision circuitry must take this into account. The Pixel Bias node is biased as low as the amplifier will allow at good stable operation to minimize the dark current. During pixel integration, the left side of the capacitor 40 will still be Pixel_Bias+Offset, but the right side is connected to the amplifier output and will increase from Bias_Blk_Ref to VDD with a slope determined by the diode current and the size of the feedback capacitor 40. Any offset error in the amplifier is compensated for in the capacitor, so that when it is used for integration, the output of the amplifier after reset is ideally Bias_Blk_Ref and any light (and dark current) will be summed at the output over the entire exposure time.

Since the voltage on the pixel is kept constant via feedback from the amplifer, the capacitive load (indicated by C=Load) on the Pixel node is irrelevant since a capacitor with a constant voltage doesn't draw any current. The end result is that the conversion gain (=|V/e>>) is determined by the feedback capacitor alone and any capacitive loads—either in the pixel diode or signal routing—will not affect the conversion gain at all. Another benefit is that the kTC noise during reset is influenced by the added capacitive load to yield a much lower noise. The “full-well” potential of the photodiode 42 (or saturation) is not determined by the pixel capacity and reset voltage, but rather by the amplifiers maximum voltage output.

While the invention has been described in reference to a preferred embodiment, it should be clear that the invention is not limited to that precise embodiment, and that many variations and modifications are possible without departing from the scope and spirit of this invention.

I claim:

1. Current mode pixel amplifier arrangement, comprising
a) a photosensitive element that has one electrode connected to a common terminal and a signal electrode;
b) a load capacitance parallel to said photosensitive element;
c) an amplifier having a first input connected to said signal electrode; a second input connected to a point of pixel bias; and an output;
d) a feedback capacitor connected between the first input of the amplifier and said amplifier output, with an integration switch situated between the feedback capacitor and the amplifier output;
e) means for placing a black level bias on said feedback capacitor; and
f) means for resetting the feedback capacitor.

2. Current mode pixel amplifier arrangement as in claim 1, the said current mode pixel amplifier arrangement is for linear array.

3. Current mode pixel amplifier arrangement as in claim 1, the said current mode pixel amplifier arrangement is for a two dimensional array of N rows and M columns.
